(19) United States
(12) Patent Application Publication
(10) Pub. No.: US 2004/0098614 A1
(43) Pub. Date: May 20, 2004

(54) JAAS security and COBRA security integration

(75) Inventors: David Yu Chang, Austin, TX (US); Ching-Yun Chao, Austin, TX (US); Hyen Vui Chung, Round Rock, TX (US); Vishwanath Venkataramappa, Austin, TX (US)

Correspondence Address: BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY

(21) Appl. No.: 10/294,993

(22) Filed: Nov. 14, 2002

(51) Int. Cl. H04L 9/00

(52) U.S. Cl. 713/201

(57) ABSTRACT

Integrating Java and CORBA security, including executing Java authentication of a client, including creating a Java credential object associated with a Java subject object, executing CORBA authentication of the client, including creating a CORBA credential object, and associating the CORBA credential object with the Java subject object.

### BACKGROUND OF THE INVENTION

1. Field of the Invention

The field of the invention is data processing, or, more specifically, methods, systems, and products for integrating JAAS and CORBA computer systems security.

2. Description of Related Art

Computer systems, in administration of computer security, provide authentication, authorization, integrity and privacy. Integrity is confirmation that a transmitted message is unaltered in transmission. Privacy generally refers to encryption of the contents of a message so that person other than its intended recipient cannot read the message. Authentication is verification of the identity of a client who requests access to a resource on a computer system. Authorization is verification that the client is authorized to access a resource on a computer system. Integrity and privacy are important aspects of computer security. This disclosure, however, is particularly concerned with authentication and authorization.

The Java Authentication and Authorization Service (“JAAS”) provides classes and interface definitions for use in authentication and authorization in Java environments. Because of this disclosure's focus on authentication and authorization, references in this disclosure to Java security features generally are references also to JAAS security features. That is, depending on context, ‘Java’ often means ‘JAAS,’ and vice versa.

A ‘client’ in this disclosure is an entity that asserts requests of computer system, which requests are subject to computer security controls, particularly authentication and authorization. A client can be a person, a software process, a thread of execution, a software service, or a process, thread, or service acting on behalf of a person, process, thread, or service.

A ‘request’ of a computer system is any form of access to computer resources on behalf of a client. Requests include requests for ‘read’ access to files and requests for ‘write’ access to files. A request most commonly discussed in this disclosure is a request to execute a member method in a target CORBA object. Such requests are also described as ‘calls’ to member methods. Such calls can be local or remote.

In this sense, Java security defines a ‘subject’ to represent the source of a request. That is, in Java security, a ‘subject’ represents a ‘client’ in the terminology of this disclosure. A Java subject object therefore may represent any entity, including persons, software processes, computer service, and so on. In JAAS security, a subject typically is represented by an object of the javax.security.auth.Subject class.

Authentication typically involves the subject demonstrating some form of evidence to prove its identity. Such evidence may be information only the subject would likely know or have (such as a password or fingerprint), or it may be information only the subject could produce (such as signed data using a private key). In this disclosure, data comprising evidence of identity of a client is referred to as ‘authentication data’ or ‘security data.’

In Java security, authenticating a client includes associating principals with a subject object. In JAAS, principals are represented by type java.security.Principal. A Java principal is a name for a client, a particular identity for use, for example, with a particular security system. Just as one client can have many names, a subject may have many principals. For example, a client may be a person having a name principal (“John Doe”) and a principal for a social security number (“123-45-6789”), which distinguish it from other subjects.

In addition to associated principals, a Java subject usually has also associated security attributes known as ‘credentials.’ A credential may contain information used to authenticate the subject to new services. Such credentials include, for example, PINs, passwords, Kerberos tickets, public key certificates, and so on. Credentials also can contain data that enables the client to perform certain activities. Cryptographic keys represent credentials that enable a client to sign or encrypt data, for example, in the interest of integrity or privacy rather than authentication.

It is useful to note that credential classes are not defined in the JAAS specification. A credential can be any Java object. More particularly, any Java object of any Java class can be associated with a Java subject as a credential object.

The Object Management Group (“OMG”) is an open membership, not-for-profit consortium that produces and maintains computer industry specifications for interoperable enterprise applications. The Security Service Specification, version 1.8, dated March 2002, is one of the computer industry specifications for interoperable enterprise applications produced by the OMG. The Security Service Specification describes a security reference model that provides the overall framework for CORBA security. The Common Secure Interoperability Specification, version 2 (“CSIv2”), is another of the computer industry specifications for interoperable enterprise applications produced by the OMG. CSIv2 defines the Security Attribute Service (“SAS”), a CORBA security protocol supporting interoperable authentication and authorization. The Security Service Specification and the CSIv2 specification, as well as the CORBA specification and all other OMG specifications referred to in this disclosure, are available for inspection and download from the OMG website at www.omg.org.

“CORBA” refers to the Common Object Request Broker Architecture, another of the computer industry specifications for interopable enterprise applications produced by the OMG. CORBA is a standard for remote procedure invocation first published by the OMG in 1991 . CORBA can be considered a kind of object-oriented way of making “RPCs” or remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

Whenever a client program acquires an object reference, decoded from a stringified object reference, from a Naming Service, or as result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds the methods' implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class.

A prior art Common Object Request Broker Architecture (“CORBA”) architecture of a kind useful with many embodiments of the present invention is set forth in FIG. 6. FIG. 6 shows a client (102) coupled for application purposes through an IDL stub (710) to an Object Request Broker (“ORB”) (232). The ORB is shown as a conceptual ORB backbone, because clients, to the extent that they are CORBA-aware, view CORBA calls from clients as being calls to a local ORB even though ORB software as such resides also to a large extent on servers. Each client knows how to contact at least one local ORB, and ORBs generally can be viewed as comprising a backbone coupled through, for example, ‘IIOP,’ the Internet Inter-ORB Protocol. FIG. 6 also shows a server (706) coupled to the ORB (232) through an IDL skeleton (712). “IDL” refers to CORBA's Interface Definition Language. IDL stubs and skeletons map client requests, or invocations of member methods in CORBA target objects, to the IDL understood by the ORB.

The client in FIG. 6 is shown as comprising a client application called a browser (704). Although many client applications in fact comprise browsers, many different kinds of client applications invoke target CORBA objects. Therefore, in this disclosure, for generality and clarity we speak generally of “clients” as including client applications, rather than confusingly distinguishing the two. Server-side applications are known often referred to as “servants” (208), but for similar reasons of generality and clarity, in this disclosure, unless a particular context requires otherwise, server-side application functionality is generally referred to as CORBA target objects—or as member methods in CORBA target objects.

FIG. 6 also depicts a standard protocol stack for secure networked data communications in the CORBA architecture. The stack includes a transport and network layer, tcp/ip (720); a security transport layer, the Secure Sockets Layer or “SSL” (718); and an inter-ORB protocol communications layer labeled “GIOP/IIOP” (716). Strictly speaking, “tcp,” the “Transmission Control Protocol,” is a separate layer residing above “ip,” the “Internet Protocol.” The two are so often spoken of together, however, that they are labeled together in FIG. 6. “GIOP” is the General Inter-ORB Protocol, a messaging protocol for communication of CORBA requests and replies, and “IIOP” is the Internet Inter-ORB Protocol, an internet version of GIOP. That is, IIOP is an internet-oriented implementation of GIOP, which is why these two also are labeled together in FIG. 6.

In CORBA security, a ‘principal’ is a human user or system entity that is capable of authentication to a CORBA security service. That is, in CORBA security, the term ‘principal’ means ‘client,’ as client is defined in this disclosure. In Java security, ‘principal’ refers a particular name for a client rather than the client itself. To reduce the risk of confusion due to using the same word to refer to two different things in Java security and in CORBA security, the term ‘client’ is used in this disclosure.

In CORBA security, authentication data is contained in credential objects. Again, the same word, ‘credential,’ is used in Java security with approximately the same meaning, except that in CORBA security, a client's identity in the sense of a name for the client is considered just another security attribute in a credential object, whereas in the Java security, there is a separate name object called a principal. In both CORBA and Java, however, it is credential objects that hold data needed to authenticate identities of clients, passwords, PINs, smart card tokens, retinal images, thumbprint images, and so on.

When a client is authenticated in CORBA security, a credential object representing authentication of that client is associated with a security current object in a CORBA security service in an object request broker (“ORB”). When a client has already been authenticated, then processes needing the client's credentials can obtain them from the security current object. If a principal logs on without authentication, only to use public services not requiring presentation of authenticated privileges, a Credentials object may be created containing no authentication data. If the principal has not been authenticated, but uses services that require authentication, then authentication can be carried out after logon, when a client requests access to a service requiring authentication.

In CORBA security, a security current object represents a current execution context at both the principal and target objects. A security current object represents service-specific state information associated with the current execution context. In this disclosure, most service-specific information of concern is specific to a CORBA security service. Both client and server applications have security current objects that represent the state associated with a thread of execution and the process in which the thread is executing.

In CORBA security, a principal authenticator object is an application-visible object responsible for the creation of credentials representing authentication of a client. A client at logon provides identity and authentication data (such as a password) to an authenticate( ) method in a principal authenticator object, which authenticates the client (in this example, a user logging on to a system), establishes a credentials object containing authenticated identity and privilege data, and associates the credentials object with a security current object in a CORBA security service.

In CORBA security, the term ‘user sponsor’ refers to code that calls the CORBA security functions for user authentication, such as, for example, a login routine that prompts for authentication data and then calls PrincipalAuthenticator.authenticate( ) to create a credential object. Sponsor code need not be an object, and no interface to it is defined. In this disclosure, the term ‘client’ is used to refer both to users and also to code acting on behalf of users. This disclosure therefore, for purposes of clarity in explaining the present invention, generally uses ‘client’ with the same meaning as ‘sponsor.’

A CORBA credentials object holds the security attributes of a principal, which in this disclosure is referred to as a client. These security attributes include a client's authenticated (or unauthenticated) identities and privileges and information for establishing security associations. A CORBA credential object provides operations to obtain and set security attributes of the client it represents.

Requests for invocation of member methods in target CORBA objects are communicated through an ORB in request messages having security contexts. A ‘context’ is a data structure in a CORBA request message that contains, among other things, a credential object representing authentication of the client for the request. A CORBA current object represents the current security context at both client and target objects. A current object provides member methods for access to credentials.

JAAS is a standard security programming model for the Java platform. The CORBA security service is a standard security model for distributed object computing environments. JAAS presently has no security support for computing with distributed objects. CORBA security services presently provide no support for authentication through JAAS. More particularly, in a system that authenticates users at logon through JAAS, the authentication so effected is not useful for remote invocations of CORBA targets. When a Java process in such an environment obtains a reference to a remote CORBA target and invokes a method in the remote CORBA target, either the call fails for lack of proper authentication or CORBA authentication is invoked in a prompting fashion at that time. Neither result is advantageous. In such an example, the fact that the client is already authenticated by JAAS in a Java environment is useless to the client in making the remote method invocation through CORBA. It would be very useful, therefore, to have ways of integrating these two security models into a Java distributed object computing environment.

### SUMMARY OF THE INVENTION

Exemplary embodiments of the invention typically include methods of integrating Java and CORBA security. Exemplary embodiments include executing Java authentication of a client, including creating a Java credential object associated with a Java subject object. Such embodiments include executing CORBA authentication of the client, including creating a CORBA credential object, and associating the CORBA credential object with the Java subject object.

In exemplary embodiments of the invention, executing CORBA authentication includes associating the CORBA credential object with a CORBA security current object of a CORBA security service. Such embodiments include calling, for the client, from the Java environment, a method in a CORBA target, and retrieving from the Java subject object a reference to the CORBA credential object. Typical embodiments include associating the CORBA credential object with a CORBA security current object of a CORBA security service. Exemplary embodiments include calling, for the client, from the Java environment, a method in a CORBA target in a target Java environment, and creating, from the CORBA credential object a Java subject object in the target Java environment.

Exemplary embodiments of the invention include methods for integrating Java and CORBA security. Such embodiments include calling, for a client, from a Java environment, a method in a target CORBA object, and determining that no CORBA credential object for the client is associated with a security current object of a CORBA security service. Typical embodiments include determining that no CORBA credentials object for the client is available from a Java subject object. Such embodiments include executing CORBA authentication of the client, including prompting the client for authentication data, inserting the authentication data into a CORBA credential object, and associating the CORBA credential object with the CORBA security current object of the CORBA security service.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a data flow diagram depicting a method of integrating Java and CORBA security.

FIG. 2 sets forth a data flow diagram depicting a further method of integrating Java and CORBA security.

FIG. 3 sets forth a data flow diagram depicting a still further method for integrating Java and CORBA security.

FIG. 4 sets forth a class relationship diagram illustrating relations among a set of classes useful with many embodiments of the present invention.

FIG. 5 sets forth a calling sequence diagram illustrating sequence of calls among member methods useful with various embodiments of the present invention.

FIG. 6 illustrates an exemplary prior art CORBA architecture useful with various embodiments of the present invention.

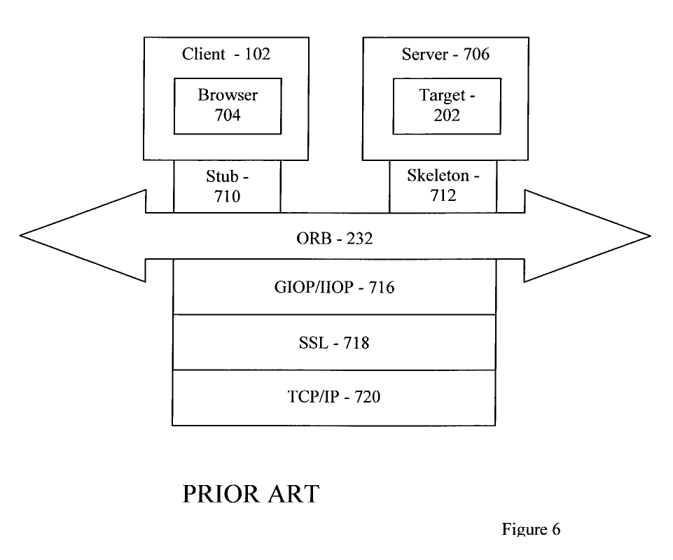

### DETAILED DESCRIPTION OF EXEMPLARY EMBODIMENTS

### Introduction

The present invention is described to a large extent in this specification in terms of methods for integrating JAAS and CORBA computer systems security. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute,” unless the context indicates otherwise, generally are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.” Aggregates of records are referred to as “tables” or “files.” Aggregates of files are referred to as “databases.”

‘API’ abbreviates ‘application programming interface,’ a set of routines and tools for building software applications. APIs provide building blocks for programmers to use in developing software applications. In particular in this disclosure, a LoginHelper class provides an API for use by programmers in building applications that integrate Java security and CORBA security.

‘Associate’ or ‘associated’ in this disclosure, subject to context, generally means associate by reference. That a first object is ‘associated’ with a second object means that the second object possesses a reference to the first object. The function of associating an object with another object often is carried out by use of ‘set’ functions, member methods established for that purpose, such as, for example, subject.setPrincipals( ), subject.setPublicCredentials( ), and subject.setPrivateCredentials.

“LTPA” is IBM's cookie-based Lightweight Third Party Authentication protocol. LTPA is implemented with an IBM plug-in for web security servers called the Access Manager Plug-in for Web Servers.

When a client makes an identity-asserting CORBA call to a target using LTPA authentication, the client first authenticates to the plug-in. Upon successful authentication, the plug-in generates an LTPA cookie on behalf of the principal. The LTPA cookie, which serves as an authentication token for the target (which is typically a web application server), contains principal identity and password information. LTPA authentication is an underlying security mechanism often available for use by CORBA security services in embodiments of the present invention.

“Kerberos” is a network authentication protocol developed by and freely available from Massachusetts Institute of Technology. The Kerberos protocol uses strong, secret-key cryptography so that a client can prove its identity to a target server (and vice versa) across an insecure network connection. To scale large networks like the Internet, more than one KDC is needed. Large networks using Kerberos authentication are divided into ‘realms.’ The complete Kerberos specification is available for review or download from http://web.mit.edu/kerberos. A free implementation of Kerberos is available from MIT, and Kerberos is available in many commercial products as well. Kerberos authentication is an underlying security mechanism often available for use by CORBA security services in embodiments of the present invention.

“Basic Authentication” refers to one of the standard authentication protocols supported by IIS. Basic Authentication pops up a GUI window on a browser and prompts a user for a user name and password. Then Basic Authentication brings the user name and password back across a network from the browser to the IIS server. Basic Authentication is an underlying security mechanism often available for use by CORBA security services in embodiments of the present invention.

“DCE” refers to the Distributed Computing Environment, a middleware system from The Open Group. DCE services include remote procedure call (“RPC”), security services including authentication, directory service, time service, threads service, and distributed file service. DCE meets the CORBA specification as an “Environmental Specific Inter Orb Protocol.”

“GIOP” means General Inter-ORB Protocol, the CORBA protocol that defines structures and formats for passing messages among heterogeneous computers and their various architectures. GIOP is not based on any particular network protocol, like IPX or TCP/IP. In order to support interoperability, the OMG defines GIOP on top of a specific transport that will be supported by all vendors. Interoperability is not provided when there is a detailed and compact message specification that is nevertheless implemented by vendors over different transport mechanisms. The OMG therefore took the additional step of standardizing GIOP over the most widely used communication transport platform: tcp/ip. GIOP defined to function over tcp/ip is called “IIOP,” the Internet Inter-ORB Protocol. Because of the general usefulness of tcp/ip, this disclosure, in describing example embodiments, tends to use the terms GIOP and IIOP used more or less interchangeably, although the use of the term IIOP is not intended to limit application of embodiments of the present invention to the single transport protocol suite tcp/ip.

“IDL” refers to CORBA's Interface Definition Language, the CORBA standard for describing interfaces of CORBA objects.

An “intercepter” is a CORBA component designed to intercept the flow of ORB processing at specific points so that CORBA services can query request information and manipulate service contexts propagated between clients and servers. ORBs use intercepters for processing both requests and replies. A primary use of request intercepters is to enable CORBA services to transfer context information between clients and servers. ORBs use intercepters both client-side and server-side in CORBA message processing. Each intercepter in use is registered with an ORB, and the ORB calls each intercepter in a predetermined order in carrying out CORBA message processing.

“IIS” means Internet Information Server, Microsoft's web server that runs on Windows NT platforms.

“IOR” means Interoperable Object reference. In order to access a remote object, a CORBA client first needs the servant's address. This information is contained in ‘object references.’ While in older revisions the handling of object references was an implementation detail, they have been standardized in modern CORBA in an effort to provide interoperability among different Object Request Brokers (“ORBs”).

An “ORB” is a CORBA Object Request Broker.

“SSL” means Secure Sockets Layer, a protocol developed by Netscape for transmitting private documents via the Internet. SSL works by using a public key to encrypt data that's transferred over an SSL connection. Modern browsers support SSL, and many Web sites use SSL to obtain confidential user information, such as credit card numbers. By convention, URLs that require an SSL connection start with ‘HTTPS’ instead of ‘HTTP.’

“Service Contexts” are data structures communicated in GIOP messages. GIOP messages allow for implicit service-related information to be passed in requests and replies. When a client sends a request to a remote object, there may be information in the client execution context (such as an open transaction context) that will affect how the request will be executed on the server. A client ORB is responsible for obtaining this information from the object service that manages it, and sending it as part of the request message. This disclosure is particularly concerned with such processing for contexts for security services, that is, ‘security contexts.’ Replies may similarly return information that may be added to the client's context before returning from the operation invocation.

### Integrating Java Security and CORBA Security

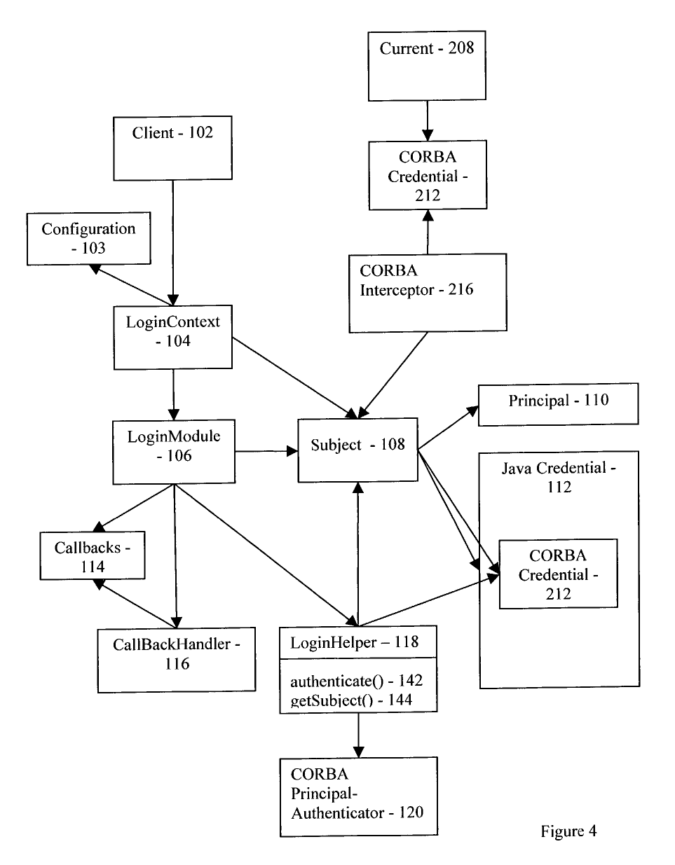

FIG. 4 sets forth a class relationship diagram illustrating relations among a set of classes useful with many embodiments of the present invention. The particular classes and relations in FIG. 4 are selected for usefulness in explaining the methods and means of the present invention, not for limitation. Many other classes and relations useful with various embodiments will occur to those of skill in the art, and all such classes are well within the scope of the present invention.

The classes of FIG. 4 include the core JAAS login classes, LoginContext (104), a JAAS login configuration class here named ‘Configuration’ (103), LoginModule (106), CallBackHandler (116), and Callback (114). A subject class (108) is an output of JAAS authentication, holding Java principals (110) and credentials (112).

The classes of FIG. 4 include CORBA-side classes PrincipalAuthenticator (120), current (208), credential (212), and an intercepter (216). CORBA credentials (212) are illustrated also as being associated with a Java subject (108) as part of Java credentials (112). Remember that the JAAS specification requires no particular structure or interface for JAAS credentials. A login process of the present invention, therefore, is free to create CORBA credentials, load them into a Java object having the same or similar internal structure as CORBA credentials, and associate such a Java object containing CORBA credential data with a Java subject (108) for later use by, for example, an intercepter (216) in a CORBA security service.

The classes of FIG. 4 also include a LoginHelper class (118). The CORBA security model uses credentials in a security current object to authenticate and authorize a thread of execution. That is, a thread running under a CORBA security service can always find its credentials at any time during thread execution. JAAS security, however, is scoped only to a particular privileged action, through a call to Subject.doAs(subject, PrivilegedAction). Because of this difference in the scope of applications of credentials, between CORBA security and Java security, it is not feasible to integrate CORBA security and Java security simply by replacing CORBA security objects with Java security objects. What is needed is an API that can provide a CORBA credential for transport through an ORB and make it available as a JAAS credential for the scope of a JAAS privileged object.

In this example, the classes of FIG. 4, it is the LoginHelper class (118) that provides such an API. The LoginHelper class is a utility class that provides wrappers around CORBA security methods. It can be used by Java clients that need the ability to programmatically authenticate users, including retaining CORBA authentication data stored in Java credentials in Java subjects. The API provided by LoginHelper includes a member method named, in this example, ‘authenticate( )’ (142) for calling a CORBA principal authenticator (120) for CORBA authentication. The LoginHelper API also includes a member method named, in this example, ‘getsubject( )’ (144) for obtaining Java credentials from CORBA credentials in a CORBA security current object.

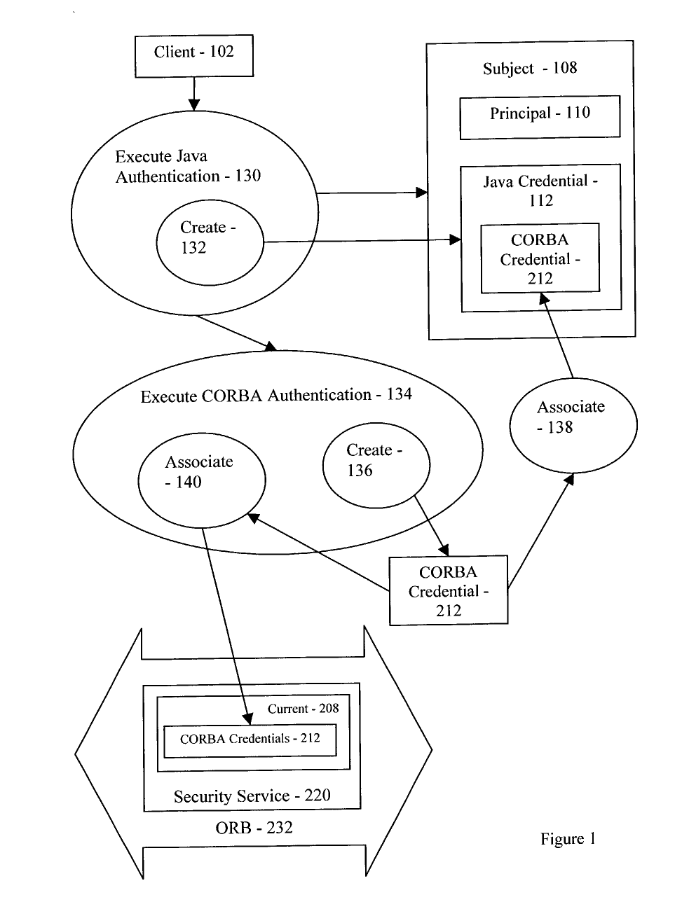

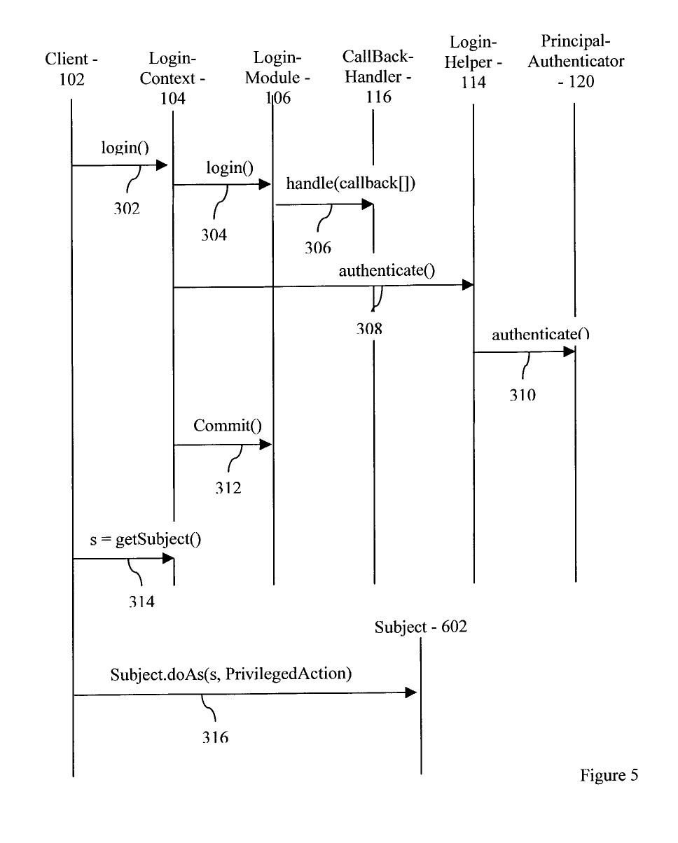

FIG. 1 sets forth a data flow diagram depicting a method of integrating Java and CORBA security that includes executing (130) Java authentication of a client (102), including creating (132) a Java credential object (112) associated with a Java subject object (108). Java authentication in this example is illustrated with respect to a JAAS login procedure, illustrated by reference to FIG. 5. A client (102) instantiates a LoginContext (104) and calls LoginContext.login( ) (302), passing as parameters a name of an entry in a configuration module and a reference to a CallBackHandler (116). The LoginContext (104) obtains from a configuration module, based upon the entry name, references to one or more LoginModules for use in authentication of the client. The LoginContext (104) calls LoginModule.login( ) (304) in each such LoginModule.

Actual gathering of Java authentication data is carried out by a CallBackHandler (116), called from a LoginModule (106) through a member method named, in this example, ‘handle( )’ (306). The ‘handle( )’ method takes as a parameter a list of references to CallBack objects, one for each particular type of authentication data needed, for example, one for user name, one for a password, one for a Kerberos realm name, one for a security token, and so on. The CallBackHandler gathers authentication data and sets it by type into CallBacks. The LoginModule gets the authentication data from the CallBacks and sets it into a Java principal and credential. The LoginContext gathers the principals and credentials into a Java subject.

The method of FIG. 1 also includes executing (134) CORBA authentication of the client (102), including creating a CORBA credential object (212). The method of FIG. 1 includes associating (138) the CORBA credential object (212) with the Java subject object (108). Consider again for explanation the example calling sequence in FIG. 5. After CallBackHandler (116) loads the callback[ ] array with authentication data, user names, passwords, and so on, all the authentication data is now available to the LoginContext in a subject object. LoginContext.login( ) then can call an API according to an embodiment of the present invention, in this example, Loginhelper.authenticate( ). Loginhelper.authenticate( ) is a Java wrapper for a call to a CORBA authentication routine, in this example, PrincipalAuthenticator.authenticate( ), which carries out actual CORBA authentication by use of an underlying authentication mechanism, basic authentication, Kerberos, LTPA, authentication under a local operating system, and so on, including any authentication mechanism as will occur to those of skill in the art, all of which are well within the scope of the present invention. Typical embodiments of the present invention provide separate concrete PrincipalAuthenticator classes for different authentication mechanism, each of which can inherit from a PrincipalAuthencator abstract class or interface. Examples of such concrete PrincipalAuthenticator classes can include:

for basic authentication on an IIS server, a concrete class named BasicAuthPrincipalAuthenticator,

for local operating system authentication on a Unix server, a concrete class named LocalOSUnixPrincipalAuthenticator,

for Kerveros authentication, a concrete class named KerberosPrincipalAuthenticator, and

for authentication under LTPA, a concrete class named LTPAPrincipalAuthenticator.

In this example, a successful call (310) to an authenticate( ) method in a PrincipalAuthenticator object (120) returns a CORBA credential object to Loginhelper (114). Loginhelper.authenticate( ) in turn, when successful, returns to the LoginContext (104) a Java credential object fashioned from the authentication data in the CORBA credential object returned from the call to PrincipalAuthenticator.authenticate( ). Remember that JAAS specifies no particular structure for credential classes. The fact that a credential object associated with a JAAS subject may contain CORBA principal identifications is of no concern whatsoever to the Java environment. Moreover, JAAS subject classes typically do implement private credential associations, typically used in embodiments of the present invention to associating JAAS credentials returned from calls to Loginhelper.authenticate( ), thereby further reducing the visibility in the Java environment of the JAAS credentials objects containing CORBA authentication data.

If all login( ) calls (304) to all LoginModules (106) succeed, LoginContext calls commit( ) (312) in each LoginModule (106). If LoginContext.login( ) returns successfully, without throwing an exception, then the client (102) can obtain a reference to its new subject object by calling (314) LoginContext.getSubject( ). The client can now use its new subject to gain authorization for a privileged action call through a call (316) to Subject.doAs( ), passing as parameters the reference to the new subject and a reference to a privileged action. In such an example, executing the privileged action can include a call to a member method in a CORBA target object.

In the method of FIG. 1, executing (134) CORBA authentication optionally also includes associating (140) the CORBA credential object (212) with a CORBA security current object (208) of a CORBA security service (220). To effect a secured call to a CORBA target, a CORBA security service will eventually need a current object containing a CORBA credential with authentication data of the kind just described above as being stored in a JAAS credential returned from a call to Loginhelper.authenticate( ). Associating (140) a CORBA credential object (212) with a CORBA security current object (208) of a CORBA security service (220), however, is said to be optional at this point in processing because it can be done later, by an intercepter, for example.

If a client (102) does not expect to make remote CORBA calls, the client can set a call parameter or an environmental parameter to advise Loginhelper.authenticate( ) to return a JAAS credential only, discarding the CORBA credential returned from a PrincipalAuthenticator. Alternatively, a client (102) or a LoginContext (104) can set a call parameter or an environmental parameter to advise Loginhelper.authenticate( ) to proceed at this time to associate (140) the CORBA credential object (212) with a CORBA security current object (208) of a CORBA security service (220). In typical embodiments, a method such as LoginHelper.authenticate( ) associates (140) a CORBA credential object (212) with a CORBA security current object (208) of a CORBA security service (220) by calling through a CORBA interface (not shown) for a local ORB (232).

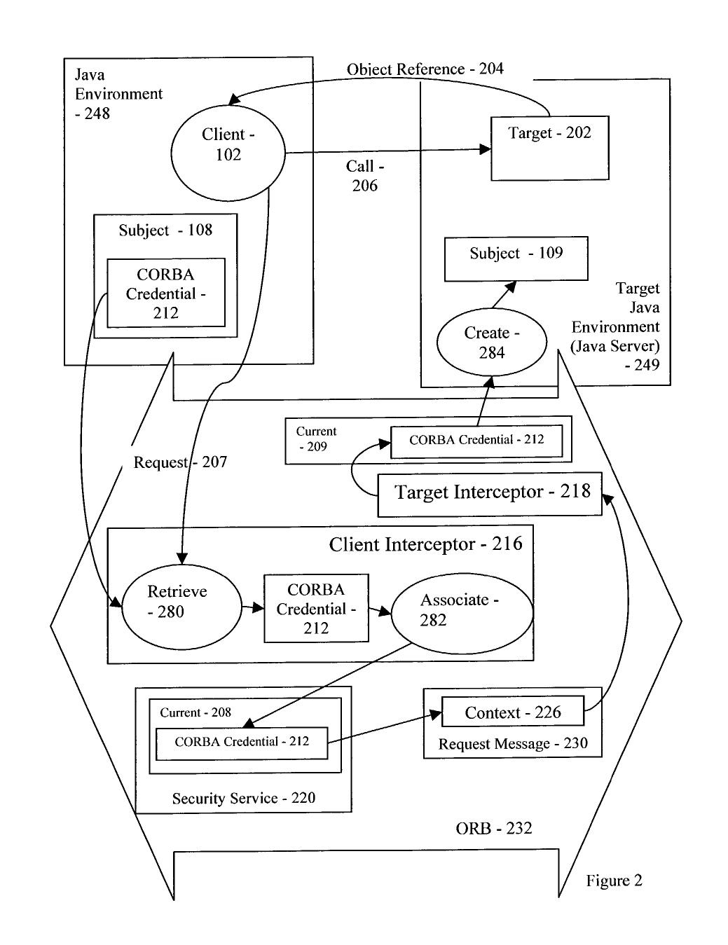

FIG. 2 sets forth a data flow diagram depicting a further method of integrating Java and CORBA security that includes calling (206, 207), for the client (102), from the Java environment, a method in a CORBA target. For a client to make a call to a CORBA target, a client needs a reference (204) to the target expressed in the programming language of the client. A client can obtain such a reference decoded from a stringified object reference, from a naming service, or as result from another method invocation. As a practical matter, many, if not most, references to CORBA objects will be obtained by clients (102) as return values from calls to other methods. Because references to client targets look to client exactly like any other reference to any object in the client's operating environment and programming language, it is very common for a client to be unaware that a particular reference is in fact a reference to a CORBA target. A call (206) to a member method in a CORBA target object appears to the client to be an otherwise ordinary call to a member method in an object.

The client accomplishes calling a method in a CORBA object by a call to Subject.doAs(s, new aPrivilegedAction( )), where ‘s’ is a reference to a JAAS subject representing the client in a Java environment. The function of subject.doAs( ) includes authorization, associating the subject ‘s’ with an AccessControlContext and determining that the client represented by the subject object ‘s’ is authorized to take the privileged action. The Subject.doAs( ) method implements execution of the privileged action if the client is found to be so authorized. From the client's point of view, this processing proceeds as a normal JAAS procedure in a Java environment. The client believes that the PrivilegedAction is a normal Java function. The client often is unaware that a PrivilegedAction refers to a CORBA target object.

The call (206) is treated in an ORB (232) as a CORBA ‘request’ (207). The ORB (232) formulates the request into a CORBA request message (230) bearing a security context (226) that communicates the client's CORBA credential (212) for the request from the client to a security current object (209) on the target side.

The method of FIG. 2 also includes retrieving (280) from the Java subject object (108) a reference to the CORBA credential object (212). The method of FIG. 2 also includes associating (282) the CORBA credential object (212) with a CORBA security current object (208) of a CORBA security service (220). As mentioned above, an authenticate( ) method in a LoginHelper optionally, in dependence upon a parameter set by a calling method higher in the hierarchy, can associate a CORBA credential (212) with a security current object (208) on the client side of the ORB. If this was not done earlier by LoginHelper.authenticate( ), for example, then a client intercepter (216) can retrieve (280) the client's CORBA credential object (212) from a Java subject object (108), and associate (282) it with the client-side security current object (208) in a CORBA security service (220).

Retrieving the CORBA credential from the Java subject can be accomplished, for example, with a call from a CORBA intercepter to subject.getPrivateCredentials( ). That is, the CORBA intercepter (216) is programmed according to an embodiment of the present invention to check whether there are CORBA credentials (212) in a security current object (208) for the principal of the CORBA request, that is, the client (102), and if not, then obtain credentials from the Java subject and set them into the CORBA current object.

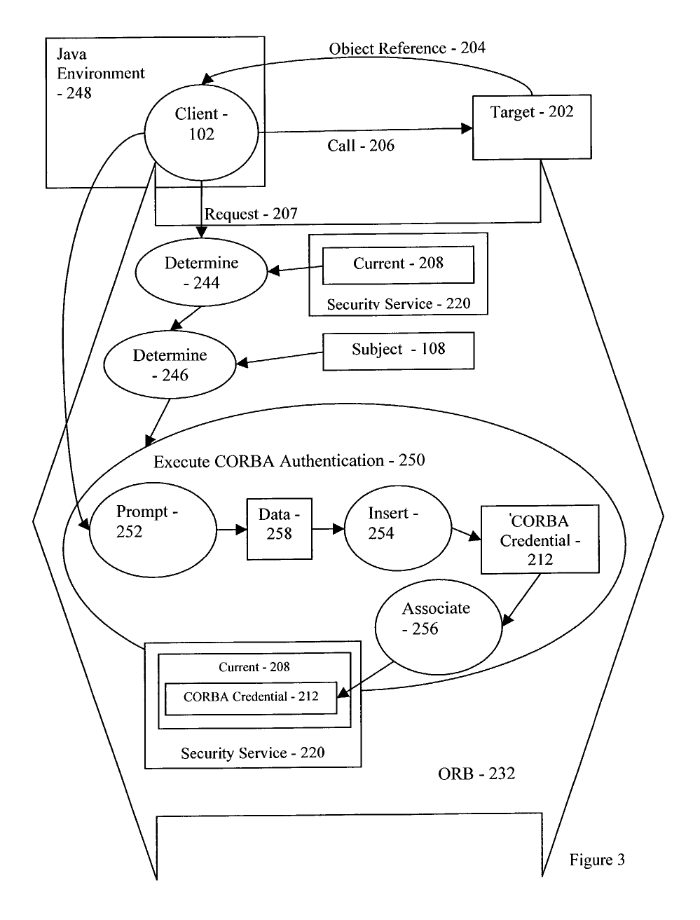

FIG. 3 sets forth a data flow diagram depicting a still further method for integrating Java and CORBA security that includes calling (206), for a client (102), from a Java environment (248), a method in a target CORBA object (202). The method of FIG. 3 also includes determining (244) that no CORBA credential object for the client is associated with a security current object (208) of a CORBA security service (220). That is, this is an example where a parameterized LoginHelper.authenticate( ) was instructed not to, and did not, associate CORBA credentials with a security current object (208) in a local ORB (232).

The method of FIG. 3 also includes determining (246) that no CORBA credentials object for the client is available from a Java subject object (108). The method of FIG. 3 also includes executing (250) CORBA authentication of the client, including prompting (252) the client (102) for authentication data (258), inserting (254) the authentication data into a CORBA credential object (212), and associating (256) the CORBA credential object with the CORBA security current object (208) of the CORBA security service (220). That is, this is an example where a client intercepter attempts to a CORBA credential object stored in a JAAS subject's private credential list for a request. If the subject.getSubject( ) returns null or returns a subject whose private credential list does not contains a CORBA credential that is valid in the client intercepter, and there is no CORBA credentials in the Security Current object (already checked), the intercepter calls a CORBA authentication function, such as, for example, PrincipalAuthenticator.authenticate( ) in a fashion that will cause a client or user to be prompted for authentication data. Otherwise the CORBA credential in the Subject's private credential list is used for the request.

Turning again to FIG. 2, a further method of integrating Java and CORBA security is illustrated as including calling (206, 207), for the client (102), from the Java environment (248), a method in a CORBA target (202) in a target Java environment (249). The illustrated method also includes creating (284), from the CORBA credential object (212) a Java subject object (109) in the target Java environment (249).

‘Target Java environment’ refers to the Java runtime environment in which the target object is located. An upcall from an ORB for a CORBA request is often to a Java server, for example, according to embodiments of the present invention. The ‘target Java environment’ therefore can be the same Java environment from which the CORBA request was initiated or a remote Java environment on a server somewhere across a network, anywhere in the world or in near space. Either way, when an upcall for a request arrives from an ORB, the target Java environment does not possess a reference to a subject object as needed for secure PrivilegedAction calls in the target environment. Hence there is a need for an API such as the one provided, for example, by LoginHelper.getSubject( ). More particularly, a Java server running in a target Java environment (249) typically will itself call a CORBA target (202) as a JAAS privileged action. In order to do that, the Java runtime environment (249) or Java server on the target side of the request in question will need a JAAS subject that does not exist on the server side when a request from the ORB first arrives on the server side.

Creating (284) a Java subject object (109) in the target Java environment (249), in embodiments according to the present invention, therefore typically includes instantiating a LoginHelper object on the target side and calling LoginHelper.getSubject( ). LoginHelper.getSubject( ) instantiates a JAAS subject object for the server side, calls through a CORBA interface into the ORB to get from the security current object the CORBA credential for the client, the CORBA principal of the present request. LoginHelper.getSubject( ) then converts the authentication data from the CORBA credential into a JAAS principal object and a JAAS credential object, associates the new JAAS principal and JAAS credential with the new subject object, and returns a reference to the new subject object.

Even more particularly, Java and CORBA security integration can be accomplished in at least one embodiment of the present invention as illustrated in the following pseudocode. ‘Pseudocode’ means the following exemplary source code, although expressed in a syntax similar to Java, is not represented to be capable of compiling or executing, but instead is presented for purposes of explanation of the exemplary embodiments of the invention.

In this example uses a LoginContext class, LoginModule class, CallbackHandler class, and Callback class to login to a local Java runtime environment. The client application deploys a Java Authentication and Authorization Service and invokes methods in a remote Java server in security mode. This example assumes that a Login configuration file contains the following entry:

CustomSample {

sample.CustomSampleLoginModule required debug=true;

};

The login( ) method of the LoginModule is programmed to call:

LoginHelper.authenticate(“bob”, “localhost”,“lqws36”);

A CORBA credential object for a CORBA security current object is created in the login( ) method of the LoginModule by calling the authenticate( ) method of a LoginHelper class. LoginModule.commit( )in this example is programmed to associate the CORBA credential object with the JAAS subject for the client.

In this example, the client program includes the following pseudocode:

import javax.security.auth.*;
import javax.security.auth.callback.*;
import javax.security.auth.login.*;
public class SampleAcn {
public static void main(String[] args) {

// Obtain a LoginContext. Tell it to use the
// LoginModule implementation specified by the
// entry named “CustomSample” in the JAAS Login
configuration
// file, and to use the specified CallbackHandler.
Subject s1 = null;
LoginContext lc = null;

try{

lc = new LoginContext(“CustomSample”,

new CallbackHandler( ));

} catch (LoginException le) {

System.out.println(“Cannot create LoginContext. ” +
le.getMessage( ));
System.exit(−1);

} catch(SecurityException se) {

System.out.printlin(“Cannot create LoginContext. ” +
se.getMessage( ));
System.exit(−1);

}
// attempt to create a JAAS subject object that
// containing a credential object

try {

lc.login( );
} catch(LoginExcpetion le) {

System.out.printlin(“Fails to create Subject. ” +
le.getMessage( ));
System.exit(−1);

}
// Get the Subject after the successful
s1 = lc.getSubject( );
// execute “ExampleAction” with authorization of subject “s1”
Subject.doAs(s1, new ExampleAction( ));

```
  } // end main( )
  class ExampleAction implements PrivilegedAction {
```

public Object run( ) {

// MyAccount is a reference to a CORBA target
// object, an Account object on a remote
// Java server. The call to MyAccount.getBalance( )
// is a call to a Java member method in a
// remote Java target object, and the ORB
// will use the CORBA credential associated
// with the JAAS subject object for the
// remote call:
Account MyAccount = new Account( );
// this is the remote call that invokes a security check:
Balance MyBalance = MyAccount.getBalance( );

} // end run( )

} // end PrivilegedAction
} // end SampleAcn

The call lc=new LoginContext(“CustomSample”, new CallbackHandler( )) instantiates a LoginContext that will run the login for the client. The LoginContext will use the CallBackHandler passed to it as a parameter and will use a LoginModule as identified for “CustomSample” in the login configuration file entry described above.

The call lc.login( ) carries out the authentication processing for the client. If lc.login( ) returns without exception, then a subject object has been successfully instantiated with an associated JAAS principal and at least one JAAS credential. Because the LoginModule methods are programmed to associate a CORBA credential as described above, the new subject in the LoginContext lc also has at least one CORBA credential associated as one of its JAAS credentials, typically as a PrivateCredential.

The call s1=lc.getSubject( ) obtains a reference to the new subject object. The call to Subject.doAs(s1, new ExampleAction( )) associates the subject object with a PrivilegedAction object for purposes of authorization to execute the run( ) method in the PrivilegedAction object. In this example, the PrivilegedAction object is an instantiation of the class ‘ExampleAction.’ The run( ) method in ExampleAction calls a member method in a CORBA object on a remote Java server, thereby invoking CORBA security. The ORB uses the CORBA credential associated with the JAAS subject object for the remote call.

A JAAS authorization check of the Subjectt.doAs( ) call is based on the AccessControlContext object in the client-side Java environment. When the call arrives target-side, the target-side Java server will call LoginHelper.getSubject( ) to obtain a subject object for authorizing the call, and then will call Subject.doAs( ) on the target side to authenticate the call on the target side in dependence upon an AccessControlContext object in the target Java environment.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of integrating Java and CORBA security, the method comprising the steps of:
executing Java authentication of a client, including creating a Java credential object associated with a Java subject object;
executing CORBA authentication of the client, including creating a CORBA credential object; and
associating the CORBA credential object with the Java subject object.

2. The method of claim 1 wherein executing CORBA authentication includes associating the CORBA credential object with a CORBA security current object of a CORBA security service.

3. The method of claim 1 further comprising:
calling, for the client, from the Java environment, a method in a CORBA target;
retrieving from the Java subject object a reference to the CORBA credential object; and
associating the CORBA credential object with a CORBA security current object of a CORBA security service.

4. The method of claim 1 further comprising:
calling, for the client, from the Java environment, a method in a CORBA target in a target Java environment; and
creating, from the CORBA credential object a Java subject object in the target Java environment.

5. A method for integrating Java and CORBA security, the method comprising the steps of:
calling, for a client, from a Java environment, a method in a target CORBA object;
determining that no CORBA credential object for the client is associated with a security current object of a CORBA security service;
determining that no CORBA credentials object for the client is available from a Java subject object; and
executing CORBA authentication of the client, including prompting the client for authentication data, inserting the authentication data into a CORBA credential object, and associating the CORBA credential object with the CORBA security current object of the CORBA security service.

6. A system for integrating Java and CORBA security, the system comprising:
means for executing Java authentication of a client, including means for creating a Java credential object associated with a Java subject object;
means for executing CORBA authentication of the client, including means for creating a CORBA credential object; and
means for associating the CORBA credential object with the Java subject object.

7. The system of claim 6 wherein means for executing CORBA authentication includes means for associating the CORBA credential object with a CORBA security current object of a CORBA security service.

8. The system of claim 6 further comprising:
means for calling, for the client, from the Java environment, a method in a CORBA target;
means for retrieving from the Java subject object a reference to the CORBA credential object; and
means for associating the CORBA credential object with a CORBA security current object of a CORBA security service.

9. The system of claim 6 further comprising:
means for calling, for the client, from the Java environment, a method in a CORBA target in a target Java environment; and
means for creating, from the CORBA credential object a Java subject object in the target Java environment.

10. A system for integrating Java and CORBA security, the system comprising:
means for calling, for a client, from a Java environment, a method in a target CORBA object;
means for determining that no CORBA credential object for the client is associated with a security current object of a CORBA security service;
means for determining that no CORBA credentials object for the client is available from a Java subject object; and
means for executing CORBA authentication of the client, including means for prompting the client for authentication data, means for inserting the authentication data into a CORBA credential object, and means for associating the CORBA credential object with the CORBA security current object of the CORBA security service.

11. A computer program product of integrating Java and CORBA security, the computer program product comprising:
a recording medium;
means, recorded on the recording medium, for executing Java authentication of a client, including means, recorded on the recording medium, for creating a Java credential object associated with a Java subject object;
means, recorded on the recording medium, for executing CORBA authentication of the client, including means, recorded on the recording medium, for creating a CORBA credential object; and
means, recorded on the recording medium, for associating the CORBA credential object with the Java subject object.

12. The computer program product of claim 6 wherein means, recorded on the recording medium, for executing CORBA authentication includes means, recorded on the recording medium, for associating the CORBA credential object with a CORBA security current object of a CORBA security service.

13. The computer program product of claim 6 further comprising:
means, recorded on the recording medium, for calling, for the client, from the Java environment, a method in a CORBA target;
means, recorded on the recording medium, for retrieving from the Java subject object a reference to the CORBA credential object; and
means for associating the CORBA credential object with a CORBA security current object of a CORBA security service.

14. The computer program product of claim 6 further comprising:
means, recorded on the recording medium, for calling, for the client, from the Java environment, a method in a CORBA target in a target Java environment; and
means, recorded on the recording medium, for creating, from the CORBA credential object a Java subject object in the target Java environment.

15. A computer program product for integrating Java and CORBA security, the computer program product comprising:
a recording medium;
means, recorded on the recording medium, for calling, for a client, from a Java environment, a method in a target CORBA object;
means, recorded on the recording medium, for determining that no CORBA credential object for the client is associated with a security current object of a CORBA security service;
means, recorded on the recording medium, for determining that no CORBA credentials object for the client is available from a Java subject object; and
means, recorded on the recording medium, for executing CORBA authentication of the client, including means, recorded on the recording medium, for prompting the client for authentication data, means, recorded on the recording medium, for inserting the authentication data into a CORBA credential object, and means, recorded on the recording medium, for associating the CORBA credential object with the CORBA security current object of the CORBA security service.
